(19) United States
(12) Patent Application Publication
(10) Pub. No.: US 2025/0111546 A1
(43) Pub. Date: Apr. 3, 2025

(54) SPARSE GLCM: GRAY-LEVEL CO-OCCURRENCE MATRIX COMPUTATION FOR POINT CLOUD PROCESSING

(71) Applicants: SONY GROUP CORPORATION, Tokyo (JP); Sony Corporation of America, New York, NY (US)

(72) Inventors: Alexandre Zaghetto, San Jose, CA (US); Danillo Graziosi, Flagstaff, AZ (US); Ali Tabatabai, Cupertino, CA (US)

(21) Appl. No.: 18/758,246

(22) Filed: Jun. 28, 2024

Related U.S. Application Data
(60) Provisional application No. 63/587,574, filed on Oct. 3, 2023.

(51) Int. Cl. G06T 9/00; G06T 7/40; G06T 7/90

(52) U.S. Cl. CPC G06T 9/001; G06T 7/40; G06T 7/90; G06T 2207/10024; G06T 2207/10028

(57) ABSTRACT

A novel method of classifying point cloud data by extending the Gray-level Co-occurrence Matrix (GLCM) technique from the 2D to the sparse 3D domain is described herein. The method is able to be applied to point clouds derived from a mesh collection/meshes (such as, the Real-World Textured Things (RWTT) mesh collection). Implementations designed for multiple purposes are described herein: sampling and quantization of RWTT meshes, generation of GLCMs and corresponding texture descriptors, and the selection of potential candidate point clouds based on these extracted descriptors.

### CROSS-REFERENCE TO RELATED APPLICATION(S)

This application claims priority under 35 U.S.C. § 119 (e) of the U.S. Provisional Patent Application Ser. No. 63/587,574, filed Oct. 3, 2023 and titled, “Sparce GLCM: Gray-level Co-occurrence Matrix Computation for Point Cloud Processing,” which is hereby incorporated by reference in its entirety for all purposes.

### FIELD OF THE INVENTION

The present invention relates to three dimensional graphics. More specifically, the present invention relates to coding of three dimensional graphics.

### BACKGROUND OF THE INVENTION

Point cloud compression is an important technology for handling large sets of 3D data points, which are used in various applications such as virtual reality (VR), augmented reality (AR), telecommunications, autonomous vehicles, and digital preservation of world heritage. The goal is to efficiently compress the vast amount of data in point clouds without significantly losing detail or accuracy.

The Moving Picture Experts Group (MPEG) has developed two main standards for point cloud compression: Geometry-based Point Cloud Compression (G-PCC) and Video-based Point Cloud Compression (V-PCC).

V-PCC leverages existing video compression technologies by projecting 3D point clouds onto 2D planes and encoding these projections as video streams. This approach is particularly advantageous for dynamic point clouds, such as those in real-time communication or interactive VR/AR environments.

G-PCC focuses on directly compressing the 3D geometric data of point clouds. G-PCC is particularly effective for static point clouds, such as those used in cultural heritage preservation, or sparse point clouds used for autonomous navigation.

Due to the success for coding 3D point clouds of the projection-based method (also known as the video-based method, or V-PCC), the standard is expected to include in future versions further 3D data, such as dynamic meshes. However, current versions of the released standards are only suitable for the transmission of an unconnected set of points, and there is still no standardized mechanism to send the connectivity of points, as it is required in dynamic mesh compression.

Due to advancements in AI-based point cloud compression, MPEG is motivated to investigate and possibly integrate AI techniques. The interest is in learning-based codecs that can manage a wide range of dynamic point clouds, which are crucial for applications such as immersive experiences and autonomous navigation. During the 146th MPEG meeting, the MPEG Technical Requirements (WG 2) announced a Call for Proposals (CfP) on AI-based point cloud coding technologies. An essential component of these AI-based techniques is a test set capable of challenging the efficacy of the trained models. In this context, methods capable of categorizing data set samples to ensure they significantly represent the desired use case are crucial.

### SUMMARY OF THE INVENTION

A novel method of classifying point cloud data by extending the Gray-level Co-occurrence Matrix (GLCM) technique from the 2D to the sparse 3D domain is described herein. The method is able to be applied to point clouds derived from a mesh collection/meshes (such as, the Real-World Textured Things (RWTT) mesh collection). Implementations designed for multiple purposes are described herein: sampling and quantization of RWTT meshes, generation of GLCMs and corresponding texture descriptors, and the selection of potential candidate point clouds based on these extracted descriptors.

In one aspect, a method programmed in a non-transitory memory of a device comprising: finding a set of voxels, computing a Gray-level Co-occurrence Matrix (GLCM) based on colors of two furthest voxels in the set of voxels for each GLCM channel and calculating texture metrics from the GLCM. One GLCM per channel is computed when there are multiple color channels. The method further comprises performing a color transformation that maps an original multi-stimulus color space into a dominant single-stimulus color space, and computing only one GLCM. The method further comprises using a directional, user-specified neighborhood by relaxing a search space around the voxel in a specific direction specified by a non-regular bounding box. The specific direction specified by the non-regular bounding box comprises vertical, horizontal or diagonal. The texture metrics comprise: energy, entropy, correlation, homogeneity or contrast. The method further comprises performing a point cloud classification based on the texture metrics. The set of voxels are within a 6-D joint (x, y, z, R, G, B) dimensions sparse signal.

In another aspect, an apparatus comprises a non-transitory memory for storing an application, the application for: finding a set of voxels, computing a Gray-level Co-occurrence Matrix (GLCM) based on colors of two furthest voxels in the set of voxels for each GLCM channel and calculating texture metrics from the GLCM and a processor coupled to the memory, the processor configured for processing the application. One GLCM per channel is computed when there are multiple color channels. The application is configured for performing a color transformation that maps an original multi-stimulus color space into a dominant single-stimulus color space, and computing only one GLCM. The application is configured for using a directional, user-specified neighborhood by relaxing a search space around the voxel in a specific direction specified by a non-regular bounding box. The specific direction specified by the non-regular bounding box comprises vertical, horizontal or diagonal. The texture metrics comprise: energy, entropy, correlation, homogeneity or contrast. The application is configured for performing a point cloud classification based on the texture metrics. The set of voxels are within a 6-D joint (x, y, z, R, G, B) dimensions sparse signal.

In another aspect, a system comprises an encoder configured for: finding a set of voxels, computing a Gray-level Co-occurrence Matrix (GLCM) based on colors of two furthest voxels in the set of voxels for each GLCM channel, calculating texture metrics from the GLCM and performing a point cloud classification based on the texture metrics and a decoder configured for receiving the point cloud classification. One GLCM per channel is computed in when there are multiple color channels. The encoder is configured for performing a color transformation that maps an original multi-stimulus color space into a dominant single-stimulus color space, and computing only one GLCM. The encoder is configured for using a directional, user-specified neighborhood by relaxing a search space around the voxel in a specific direction specified by a non-regular bounding box. The specific direction specified by the non-regular bounding box comprises vertical, horizontal or diagonal. The texture metrics comprise: energy, entropy, correlation, homogeneity or contrast. The set of voxels are within a 6-D joint (x, y, z, R, G, B) dimensions sparse signal.

### BRIEF DESCRIPTION OF THE DRAWINGS

FIG. 1 illustrates a diagram of spatial relationships between pixels according to some embodiments.

FIG. 2 illustrates a diagram of an exemplary Gray-Level Co-occurrence Matrix (GLCM) according to some embodiments.

FIG. 3 illustrates a diagram of a sparse GLCM in the RGB color space according to some embodiments.

FIG. 4 illustrates a diagram of directional bounding boxes according to some embodiments.

FIG. 5 illustrates a diagram of generating texture metrics according to some embodiments.

FIG. 6 illustrates a diagram of a 3D extension of the GLCM according to some embodiments.

FIG. 7 illustrates examples of Red, Green and Blue GLCMs according to some embodiments.

FIG. 8 illustrates a diagram of K-means clustering to define texture classes according to some embodiments.

FIGS. 9-11 illustrate examples of point cloud classification using the sparse GLCM according to some embodiments.

FIG. 12 illustrates a diagram of class analysis according to some embodiments.

FIGS. 13-16 illustrate how each point cloud is positioned within its corresponding class in pairs of metrics according to some embodiments.

FIG. 17 illustrates a diagram of a neural network-based attribute quality index according to some embodiments.

FIG. 18 illustrates a flowchart of implementing the sparse GLCM according to some embodiments.

FIG. 19 illustrates a block diagram of an exemplary computing device configured to implement the sparse GLCM method according to some embodiments.

### DETAILED DESCRIPTION OF THE PREFERRED EMBODIMENT

Point clouds within a dataset do not exhibit significant representation in terms of attributes. To deal with a detected deficiency, contributions have enhanced the call for proposal (CfP) test set with mesh-derived point clouds selected from the Real-World Textured Thing (RWTT) collection. Since the collection presents more then 500 models, the challenge became what models to select.

The RWTT collection includes publicly accessible textured 3D models that have been generated using contemporary off-the-shelf photo-reconstruction tools. The primary objective behind the dataset is to establish a benchmark for geometry processing algorithms that are designed to handle parametrized, textured 3D models originating from real-world sources. In addition to serving as a benchmark for geometry processing, the RWTT dataset also offers valuable attribute information in comparison to the current CfP material test set. The RWTT dataset is compose by a collection of 568 textured models, making the manual selection of models a considerable challenge. A purely subjective selection processes may not align with the objective challenges inherent in assessing the representativeness of these models.

The CfP material envisions two primary use cases: dense point clouds for Virtual Reality (VR)/Augmented Reality (AR)/Gaming, and sparse point clouds for autonomous driving and robotics.

Furthermore, it is important to note that the dense point cloud category encompasses both static and dynamic point clouds. Static dense point clouds and a novel methodology for classifying these point clouds are discussed herein. The methodology builds upon an extension of the Gray-Level Co-occurrence Matrix (GLCM) metrics, adapting them for use with point clouds. Furthermore, the methodology has been applied to the RWTT dataset, resulting in the classification of mesh-derived point clouds into distinct categories. Based on the outcomes of the classification process, a set of eighteen point clouds that have been distributed into three distinct classes. The point clouds are suggested as potential candidates for improving the existing test set, especially for attribute coding evaluation.

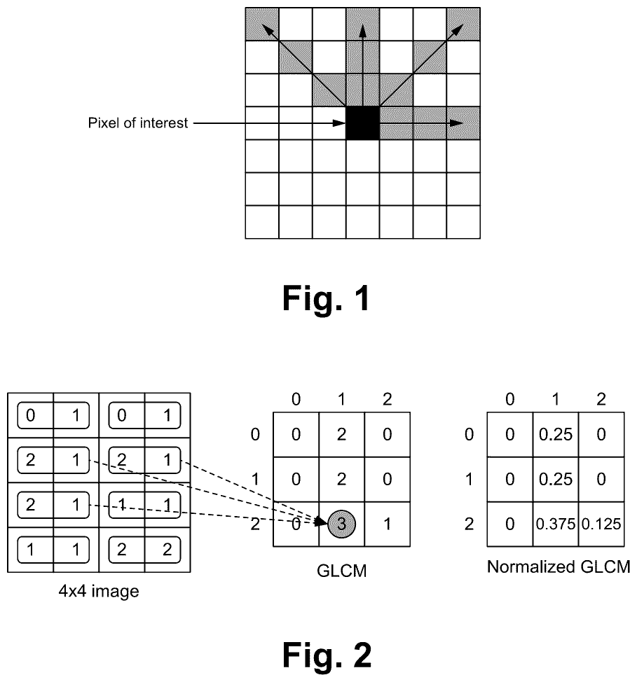

A Gray-Level Co-occurrence Matrix (GLCM) is a technique in image processing and computer vision for capturing texture information in an image. The image's pixel values are typically quantized into a set of discrete gray levels. For example, one might use 8-bit quantization, which means the pixel values range from 0 to 255. For each pixel in the quantized image, you consider its relationship with its neighboring pixels. The GLCM counts the number of times certain pairs of pixel values occur at a specified spatial relationship within the image. The spatial relationship can be defined in terms of distance and direction (e.g., horizontal, vertical, diagonal), as shown in FIG. 1.

The GLCM is constructed as a square matrix, where the rows and columns represent the different gray levels, and each element GLCM (i, j) of the matrix represents the count of pixel pairs with values (i, j) at the specified spatial relationship. To make the GLCM more robust to changes in image size and contrast, it is normalized by dividing each element by the sum of all elements in the matrix. This results in a probability matrix that represents the likelihood of observing pixel value pairs at the specified spatial relationship. FIG. 2 shows an example according to some embodiments.

Texture metrics, also known as texture features or texture descriptors, are quantitative measures that characterize the texture of an image. These metrics are calculated based on information derived from the GLCM or other texture analysis methods. Some common texture metrics that can be calculated are defined in Table 1: contrast, entropy, homogeneity, energy and correlation. These texture metrics can be used for a wide range of image analysis tasks, including image classification, segmentation, object recognition, and quality assessment.

TABLE 1

| | |
|---|---|
| Contrast | ${\sum }_{i , j = 0}^{N - 1} {{P}_{i , j} ( i - j )}^{2}$ |
| Correlation | ${\sum }_{i , j = 0}^{N - 1} {P}_{i , j} [ \frac{( i - {u}_{i} ) ( j - {u}_{j} )}{\sqrt{( {σ}_{i}^{2} ) ( {σ}_{j}^{2} )}} ]$ |
| Energy | ${\sum }_{i , j = 0}^{N - 1} {P}_{i , j}^{2}$ |
| Entropy | ${\sum }_{i , j = 0}^{N - 1} {P}_{i , j} ( - ln {P}_{i , j} )$ |
| Homogeneity | ${\sum }_{i , j = 0}^{N - 1} \frac{{P}_{i , j}}{1 + {( i - j )}^{2}}$ |

An interpretation for the metrics defined in Table 1 is:

Contrast measures the difference in intensity between neighboring pixels. A high contrast value indicates that there are significant intensity variations in the image, which corresponds to a coarse or rough texture. On the other hand, a low contrast value suggests a more uniform or smooth texture.

Entropy is a measure of randomness or disorder in the image. A high entropy value indicates that the pixel intensities are distributed in a more chaotic manner, associated with complex or noisy textures. Conversely, a low entropy value suggests a more ordered or predictable texture.

Homogeneity measures the similarity or uniformity of pixel intensities in the image. A high homogeneity value implies that neighboring pixels have similar intensity values, which is often seen in textures with fine, regular patterns. Lower values of homogeneity suggest more variation in pixel intensities.

Energy is a measure of the uniformity of pixel pairs' distribution in the GLCM. A high energy value indicates that there are fewer dominant intensity pairs in the image, resulting in a more uniform texture. Lower energy values imply that there are dominant pixel pairs, which may correspond to repetitive or structured textures.

Correlation measures the linear dependency between pixel values at different locations in the image. A high correlation value suggests that pixel intensities at different positions are strongly related, often indicating a textured region with well-defined patterns or directional features. A low correlation value implies weaker or no linear relationship between pixel values at different positions, which may be indicative of more chaotic or random textures.

Point clouds are three-dimensional (3D) representations of the surfaces of objects or environments. They are composed of a collection of individual data points, each with a set of coordinates in a 3D Cartesian coordinate system (X, Y, Z). In addition to (X, Y, Z) coordinates, point clouds can include additional attributes, such as color, reflectance and normal.

Compression of point cloud data is necessary for several reasons, such as storage and transmission efficiency.

V-PCC and Geometry-based Point Cloud Compression (G-PCC) are part of MPEG's efforts to standardize point cloud compression techniques. While V-PCC converts the point cloud data from 3D to 2D, which is then coded by 2D video encoders, G-PCC encodes the content directly in 3D space.

Originally, the first edition of G-PCC primarily targeted use cases involving static and multi-frame/fused LiDAR point clouds, particularly in the automotive application context. It lacked tools for inter-frame compression.

More recently, MPEG has been working towards a potential second edition of G-PCC with the aim of expanding its applicability to dynamic point clouds. The expansion includes the incorporation of additional tools for inter-frame coding. Specifically, the development of tools for dynamic “solid” point clouds, which were previously a focus of Versatile Video Coding for Point Clouds (V-PCC), motivated G-PCC experts to collaborate on a separate test model known as Geometry Solid-Test Model (GeS-TM).

The emerging trend involves extending G-PCC's capabilities to encompass: dynamic (inter-frame) point cloud geometry and attribute compression intended for LiDAR data, particularly in the context of automotive applications, and sparse point clouds in general; and dynamic (inter-frame) point cloud geometry and attribute compression specifically designed for “solid” point clouds.

The current G-PCC test models include tools for inter-frame geometry coding. Recent developments have expanded its capabilities to encompass inter-frame attribute coding, specifically incorporating the Inter-RAHT (Region-Adaptive Hierarchical Transform). Currently, Inter-RAHT reutilizes the motion vectors estimated for geometry to also perform inter-frame coding of attributes.

Color information is able to be used to enhance motion estimation, achieving more efficient inter-frame attribute coding while preserving the efficiency of geometry coding. A strategy that jointly uses geometry and attribute information to perform motion estimation is able to be implemented. The distortion is computed as the weighted sum of color and geometry distortions. The challenge is to optimally select the weighting factor between color and geometry, which can vary on a block-per-block basis.

One of the challenges associated with point clouds is their sparse nature. Many assumptions that are valid for 2D images cannot be directly extended to point clouds without the need for adaptation. The computation of the GLCM serves as one example, and the extension of the computational framework of GLCM to accommodate point clouds is another example.

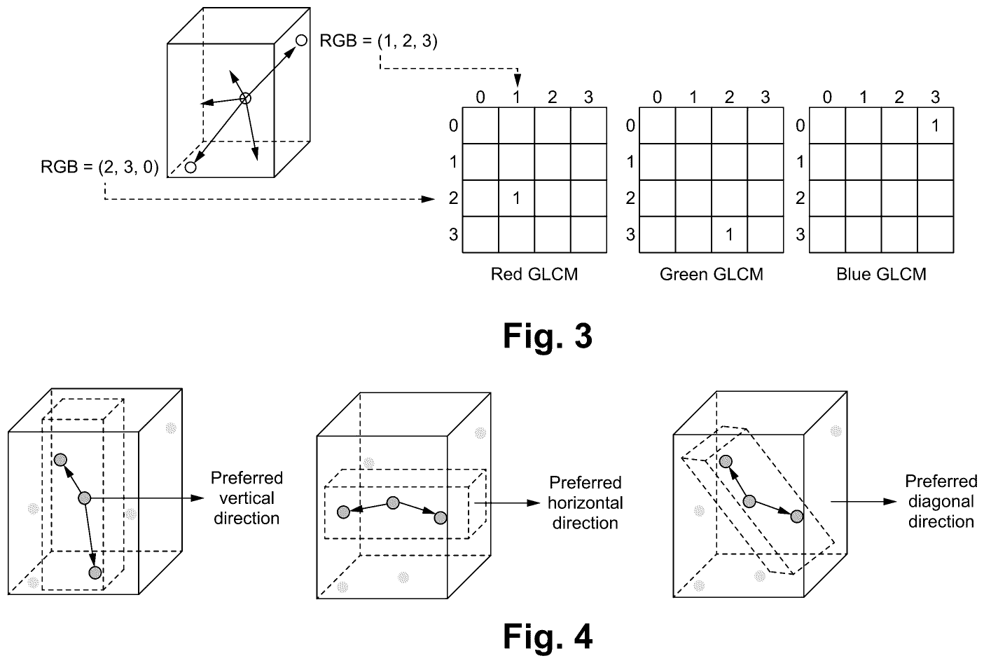

Due to the inherent sparseness of point clouds, neighboring points are not always available for reference or analysis. A more flexible definition of neighborhood within the context of point clouds is important. In the traditional definition of the GLCM, the spatial relationship can be defined in terms of distance and direction of neighboring pixels in a fully occupied grid. Since the presence of immediate neighboring voxels cannot be guaranteed, for each voxels of the point cloud, the neighborhood will be considered as the N closest voxels in any direction and distance. The approach ensures that the direction of analysis will at least roughly align with the surface direction determined by the point distribution in space. Then, the colors of two furthest voxels in the set are used as a pair to compute the GLCM. Any color space can be used. In a case of multiple color channels, one GLCM per channel is computed. The GLCM can be computed for each channel and averaged, for instance. Another option is to perform any color transformation that maps the original multi-stimulus color space into a single-stimulus dominant color space and use the single channel to compute only one GLCM. FIG. 3 illustrates the GLCM construction for the RGB color space according to some embodiments.

A directional user-specified neighborhood can also be used, by relaxing the search space around the voxel in one specific direction, as illustrated in FIG. 4. The vertical and one possible horizontal and diagonal direction are used as examples, but any directional bounding box can be used for the neighbor search.

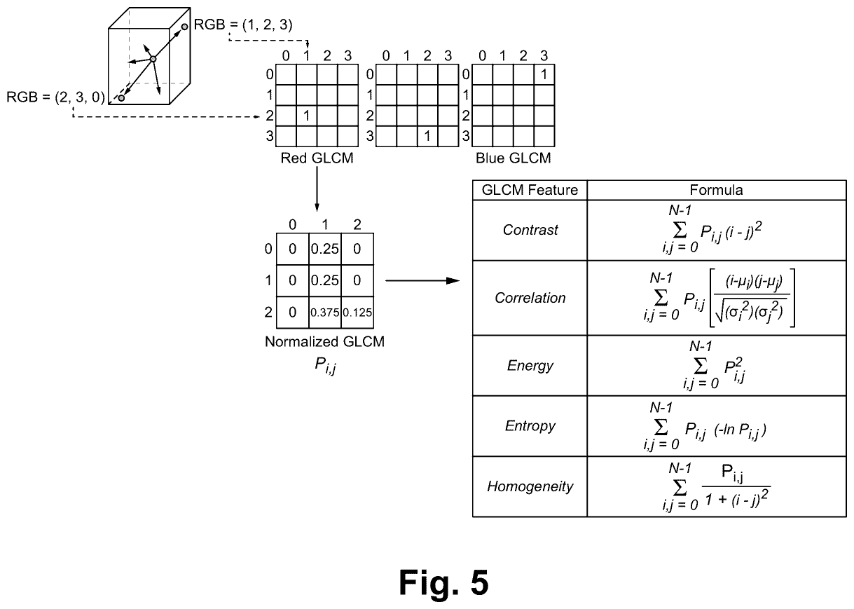

Once the GLCMs are computed, the texture metrics can be computed as defined in Table 1. FIG. 5 illustrates a diagram of sparse GLCM computation for point clouds according to some embodiments.

As an application, the sparse GLCM method is able to be used to classify point clouds into texture categories. The method is able to be applied to the RWTT dataset which has 568 models, 67 large models (greater than 1M faces), 109 models with multiple textures and 18 different pipelines.

In an exemplary implementation, the selection processes are determined as follows: mesh selection; the selected meshes are sampled and quantized using the metric software; duplicate points are removed; only the resulting point clouds with more than 500 k points are kept for analysis; the Sparse GLCM is computed for the R, G and B color components; contrast, homogeneity, energy, entropy and correlation texture metrics are computed for all 208 mesh-derived point clouds; K-means clustering is applied to the 5-dimensional metric vectors calculated to define texture classes; each point cloud in the set is classified according to its proximity to one of the class centroids; and the 6 closest point clouds for each centroid are selected as candidates. Although specific examples are provided, any modifications are possible.

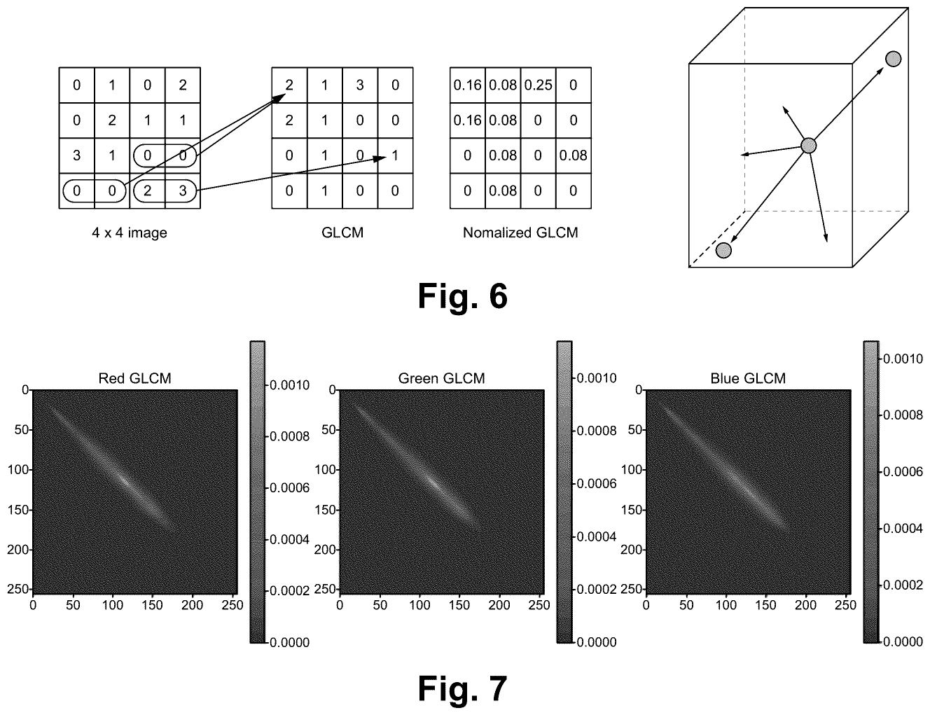

FIG. 6 illustrates a diagram of 3D extensions of the gray-level co-occurrence matrix (GLCM) computed for the R, G and B color components according to some embodiments.

In FIG. 7, examples of GLCMs for the red, green and blue channels are presented.

The following metrics are computed for each GLCMs of all 208 mesh-derived point clouds: contrast, homogeneity, energy, entropy and correlation.

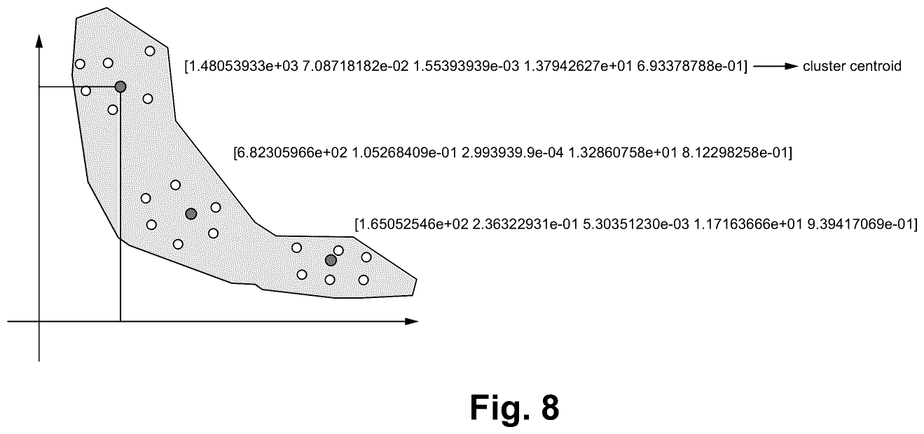

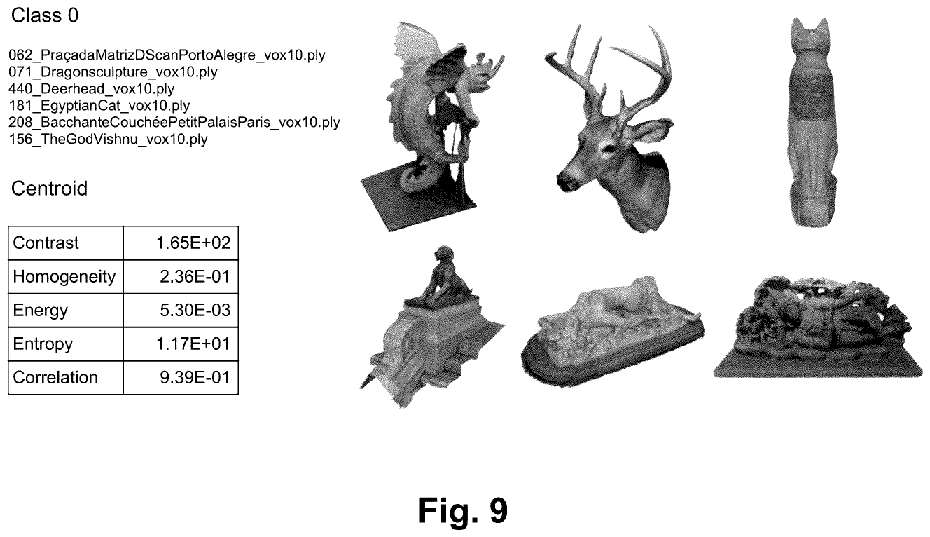

K-means clustering (or another clustering implementation) is applied to the 5-dimensional matrix vectors to define texture classes. FIG. 8 illustrates an example of three classes defined.

Each point cloud in the set is classified according to its proximity to one of the centroids.

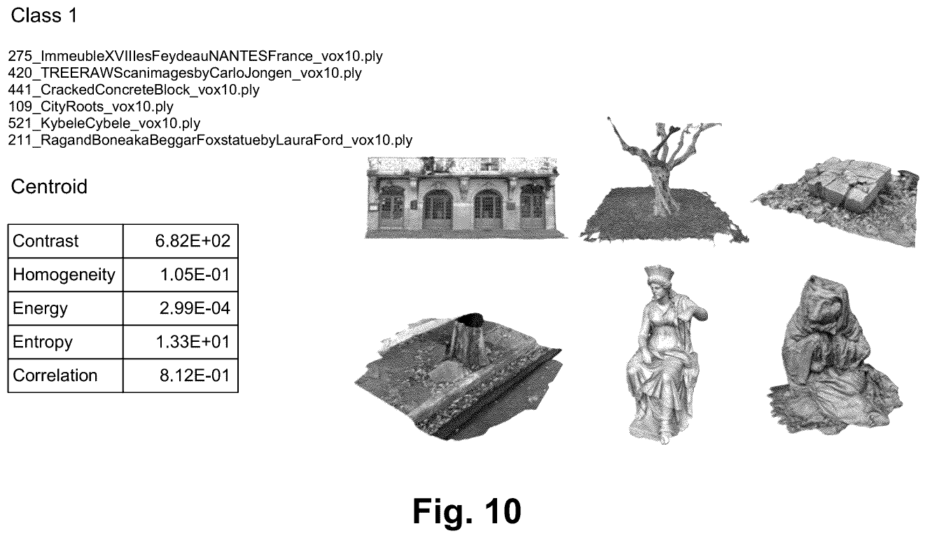

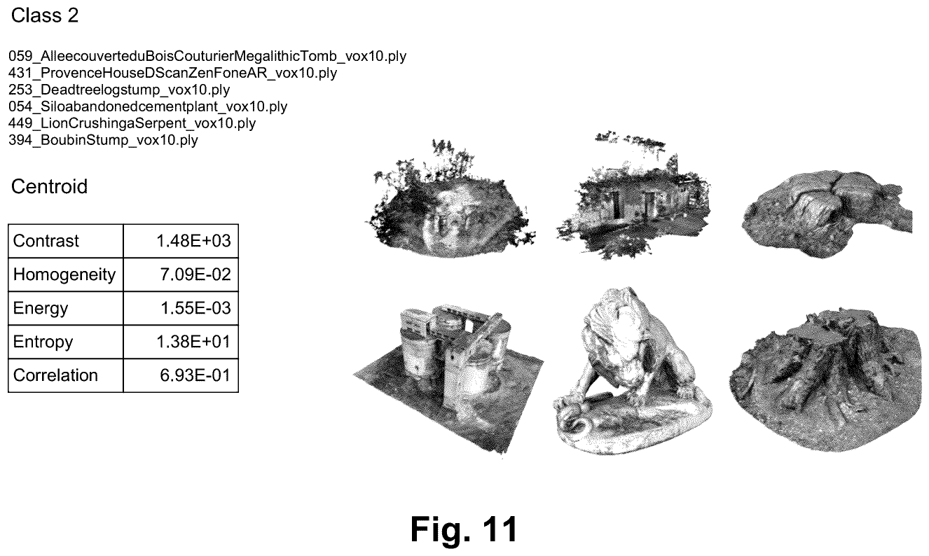

After applying the method to the RWTT collection, eighteen point clouds distributed along three classes are recommended as potential candidates. The point clouds are shown in FIGS. 9-11.

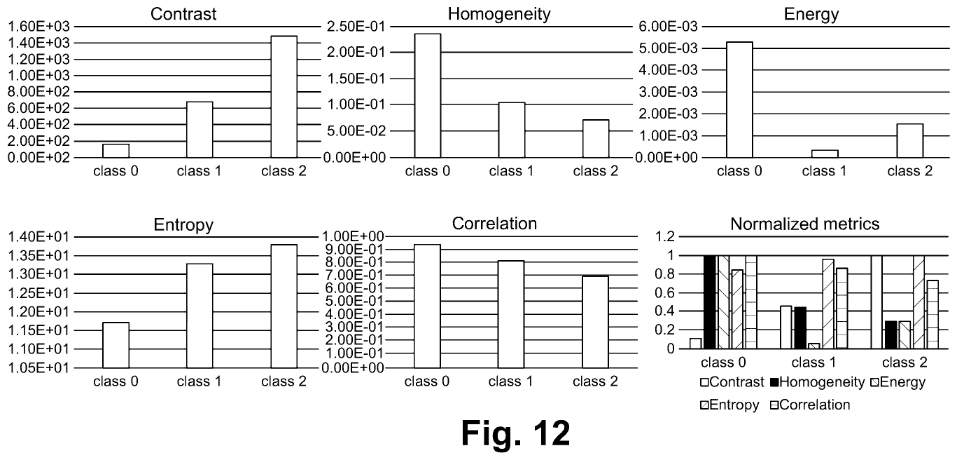

FIG. 12 shows the contrast, homogeneity, energy, entropy and correlation values of the centroids for each class according to some embodiments.

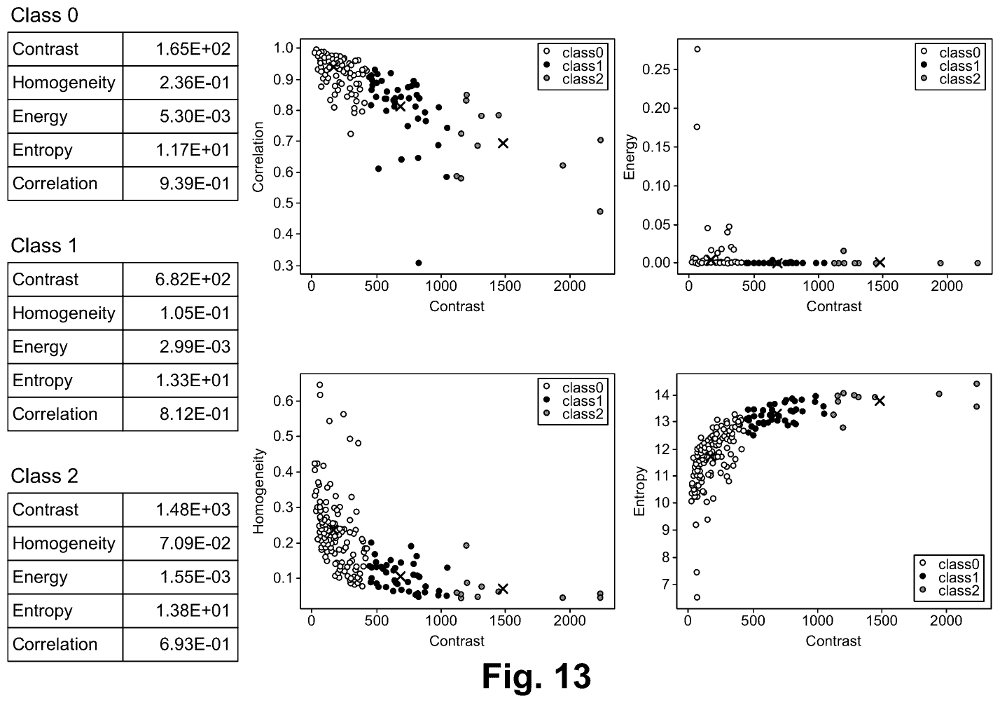

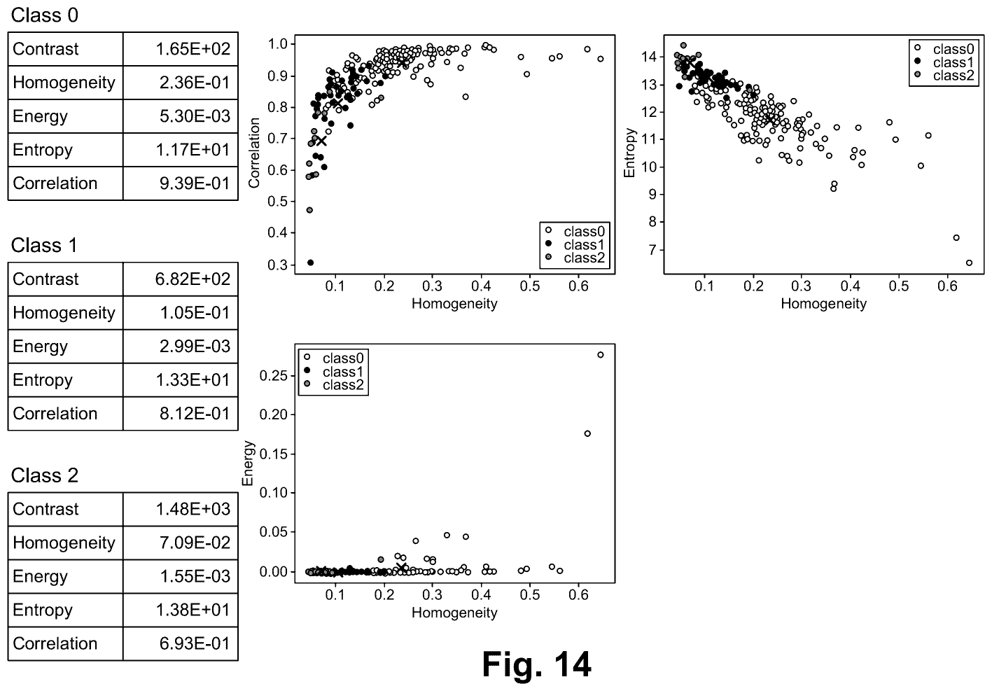

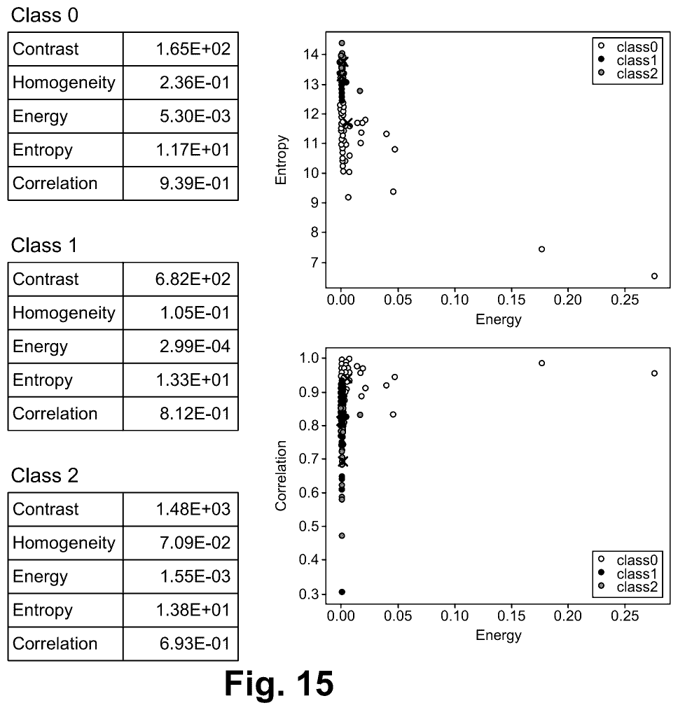

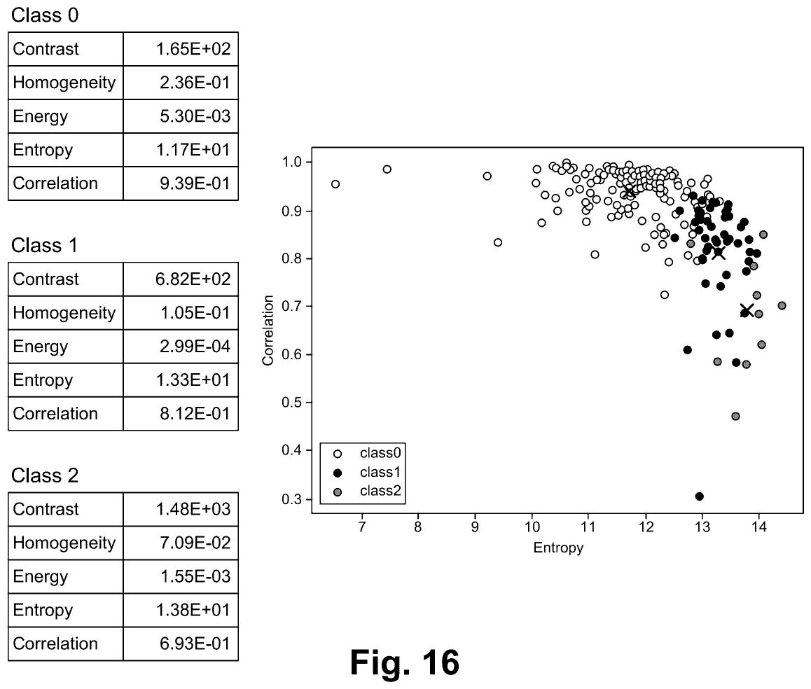

FIGS. 13-16 illustrate how each point cloud is positioned within its corresponding class in pairs of metrics. The classification actually occurs in the 5-dimensional space of all 5 texture metrics.

As mentioned, an implementation is able to jointly use geometry and attribute information to perform motion estimation. The distortion δ is computed as the weighted sum of color (δ_{c}) and geometry (δ_{g}) distortions, as follows:

$$δ = ( 1 - α ) * {δ}_{g} + α * {δ}_{c}$$

The challenge is to optimally select the weighting factor between color and geometry. The point cloud classification method previously described can be used to classify each point cloud block into one specific texture category and adjust the value of α depending on the category it belongs. Coding efficiency can be improved in a rate distortion sense, by selecting a specific alpha based on the blocks' texture information.

The sparse GLCM can individually or even jointly be used as quality metrics for point cloud attribute compression, as follows:

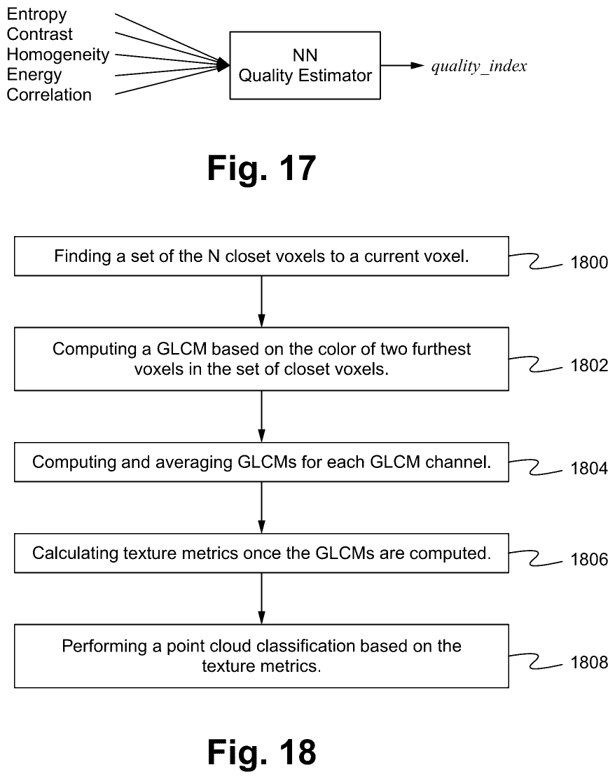

TextureQuality=α₁contrast+α₂entropy+α₃homogeneity+α₄energy+α₅correlation or even in a Neural Network-based attribute quality index, as shown in FIG. 17.

Additional implementations are able to utilized. Other GLCM metrics can be incorporated. Even though the description described herein considered 3D sparse signals (point clouds), the concept can be extended to any N-dimensional sparse signal. For instance, it could be extended to the (x, y, z) spatial domain, or (x, y, z, R, G, B). In the case of the (x, y, z, R, G, B) 6D signal, one GLCM associated with each dimension x, y, z, R, G and B can be calculated, resulting in 6 sets of descriptors. The 6 sets can be concatenated into a single unified descriptor or combined using weighting factors. The same way R, G and B GLCMs can be used to describe texture properties, the x, y and z GLCMs can be used to describe geometry properties. In addition, and x, y, z, R, G, B GLCMs derived from a joint 6D representation of each point can be used to evaluate geometry and texture in a unified manner.

With the goal of enhancing the test set by introducing more texture-rich point clouds, the objective classification approach is able to be used. Specifically, a subset of point clouds is selected from each class out of a pool of the 6 candidate point clouds.

Selecting point clouds for evaluation from a pool of more than 200 options can be a very complex task. In such scenarios, employing an objective selection method with clear rationale offers distinct advantages over relying solely on subjective judgment. An objective selection method is preferable because: (a) an objective selection method provides a systematic and repeatable process for choosing point clouds. This allows other experts to follow the same method, ensuring consistency in the selection of datasets across different activities; (b) subjective selection can introduce bias and arbitrary choices based on personal preferences; and (c) objective methods are transparent and justifiable. They allow researchers to clearly articulate the criteria behind the selection of specific point clouds.

FIG. 18 illustrates a flowchart of implementing the sparse GLCM according to some embodiments. In the step 1800, a set of the N closest voxels to a current voxel are found in any direction and distance. The N closest voxels are able to be any voxels within a set distance, or searching for voxels going from closest to farthest, and when N voxels have been found, the search for voxels stops. In the step 1802, the color of two furthest voxels (e.g., furthest from the current voxel) in the set of closest voxels is used as a pair to compute a GLCM. Any color space can be used. In a case of multiple color channels, one GLCM per channel is computed. In the step 1804, GLCMs are computed for each GLCM channel and averaged. In some embodiments, another option is to perform any color transformation that maps the original multi-stimulus color space into a dominant single-stimulus color space and use this single channel to compute only one GLCM. In some embodiments, a directional user-specified neighborhood is used by relaxing the search space around the voxel in one specific direction specified by a non-regular bounding box. In the step 1806, once the GLCMs are computed, the texture metrics are calculated as in the traditional 2D case. Some of the metrics are energy, entropy, correlation, homogeneity and contrast, but other metrics can be used. Even though 3-D sparse signals (point clouds) are described herein, the concept can be extended to any number of sparse dimensions of any signal. For instance, the concept can be extended to the 3D (x, y, z) spatial dimensions, 6-D joint (x, y, z, R, G, B) dimensions or, in general, to an N-D (x1, x2, x3, . . . , xn) sparse signal. In the case of (x, y, z, R, G, B), for instance, one GLCM associated with each component x, y, z, R, G and B is calculated, resulting in 6 sets of descriptors (metrics). The 6 sets can be concatenated into a single unified descriptor or combined using weighting factors. The same way R, G and B GLCMs can be used to describe texture properties, the x, y and z GLCMs can be used to describe geometry properties. In addition, x, y, z, R, G, B GLCMs derived from a joint 6-D representation of each point can be used to evaluate geometry and texture in a unified manner. In the step 1808, a point cloud classification is performed based on the texture metrics. In some embodiments, fewer or additional steps are implemented. In some embodiments, the order of the steps is modified.

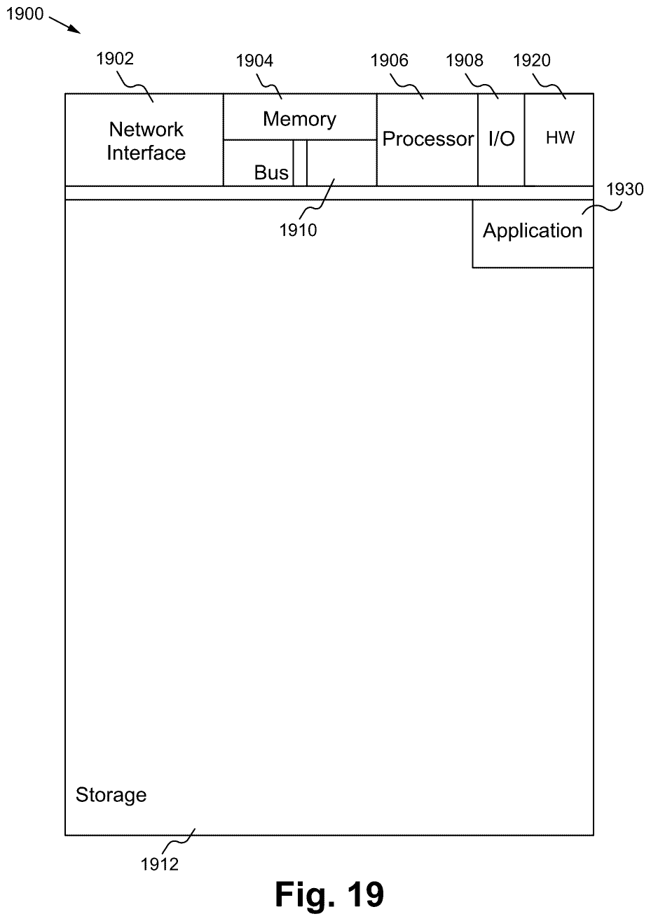

FIG. 19 illustrates a block diagram of an exemplary computing device configured to implement the sparse GLCM method according to some embodiments. The computing device 1900 is able to be used to acquire, store, compute, process, communicate and/or display information such as images and videos including 3D content. The computing device 1900 is able to implement any of the encoding/decoding aspects. In general, a hardware structure suitable for implementing the computing device 1900 includes a network interface 1902, a memory 1904, a processor 1906, I/O device(s) 1908, a bus 1910 and a storage device 1912. The choice of processor is not critical as long as a suitable processor with sufficient speed is chosen. The memory 1904 is able to be any conventional computer memory known in the art. The storage device 1912 is able to include a hard drive, CDROM, CDRW, DVD, DVDRW, High Definition disc/drive, ultra-HD drive, flash memory card or any other storage device. The computing device 1900 is able to include one or more network interfaces 1902. An example of a network interface includes a network card connected to an Ethernet or other type of LAN. The I/O device(s) 1908 are able to include one or more of the following: keyboard, mouse, monitor, screen, printer, modem, touchscreen, button interface and other devices. Sparse GLCM application(s) 1930 used to implement the sparse GLCM implementation are likely to be stored in the storage device 1912 and memory 1904 and processed as applications are typically processed. More or fewer components shown in FIG. 19 are able to be included in the computing device 1900. In some embodiments, sparse GLCM hardware 1920 is included. Although the computing device 1900 in FIG. 19 includes applications 1930 and hardware 1920 for the sparse GLCM implementation, the sparse GLCM method is able to be implemented on a computing device in hardware, firmware, software or any combination thereof. For example, in some embodiments, the sparse GLCM applications 1930 are programmed in a memory and executed using a processor. In another example, in some embodiments, the sparse GLCM hardware 1920 is programmed hardware logic including gates specifically designed to implement the sparse GLCM method.

In some embodiments, the sparse GLCM application(s) 1930 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

To utilize the sparse GLCM method, a device acquires or receives 3D content (e.g., point cloud content). The sparse GLCM method is able to be implemented with user assistance or automatically without user involvement.

In operation, the sparse GLCM method includes the extension of the computational framework of GLCM to accommodate point clouds or any multidimensional N-D sparse signal. Due to the inherent sparseness of point clouds, neighboring points are not always available for reference or analysis. A more flexible definition of neighborhood within the context of point clouds is used. In the traditional definition of the GLCM, the spatial relationship can be defined in terms of distance and direction of neighboring pixels in a fully occupied grid. Since the presence of immediate neighboring voxels in point clouds cannot be guaranteed, the definition of neighborhood is updated in order to compute the GLCM and consequently calculate the associated texture metrics. The GLCMs for point clouds can be used in multiple scenarios. First, in the context of point clouds classification, depending on the texture characteristics of an input point cloud, a codec can have its encoding parameters adjusted accordingly. For instance, more bits can be allocated for attributes, if a more complex texture pattern is identified. Second, in inter-frame coding of geometry and attributes in the context of geometry-based point cloud compression schemes, the motion vector computation needs to balance the importance of geometry and texture patterns. Currently, Inter-RAHT attribute coding in G-PCC 2nd edition reutilizes the motion vectors estimated for geometry to also perform inter-frame coding of attributes. The use of the GLCM method can help to select the weighting factor by analyzing the point clouds texture using the GLCM. Coding efficiency can be improved in a rate distortion sense, by selecting a specific alpha based on the blocks' texture information. Third, since lossy attribute coding imply in attribute degradation, and the proposed extension of GLCM to point clouds characterizes the texture of the point cloud, they can be also used as quality metrics, including in a neural network-based quality index.

### Some Embodiments of Sparse GLCM: Gray-Level Co-Occurrence Matrix Computation for Point Cloud Processing

1. A method programmed in a non-transitory memory of a device comprising:
   finding a set of voxels;
   computing a Gray-level Co-occurrence Matrix (GLCM) based on colors of two furthest voxels in the set of voxels for each GLCM channel; and
   calculating texture metrics from the GLCM.
2. The method of clause 1 wherein one GLCM per channel is computed when there are multiple color channels.
3. The method of clause 1 further comprising performing a color transformation that maps an original multi-stimulus color space into a dominant single-stimulus color space, and computing only one GLCM.
4. The method of clause 1 further comprising using a directional, user-specified neighborhood by relaxing a search space around the voxel in a specific direction specified by a non-regular bounding box.
5. The method of clause 4 wherein the specific direction specified by the non-regular bounding box comprises vertical, horizontal or diagonal.
6. The method of clause 1 wherein the texture metrics comprise: energy, entropy, correlation, homogeneity or contrast.
7. The method of clause 1 further comprising performing a point cloud classification based on the texture metrics.
8. The method of clause 1 wherein the set of voxels are within a 6-D joint (x, y, z, R, G, B) dimensions sparse signal.
9. An apparatus comprising:
   a non-transitory memory for storing an application, the application for:
      finding a set of voxels;
      computing a Gray-level Co-occurrence Matrix (GLCM) based on colors of two furthest voxels in the set of voxels for each GLCM channel; and
      calculating texture metrics from the GLCM; and
   a processor coupled to the memory, the processor configured for processing the application.
10. The apparatus of clause 9 wherein one GLCM per channel is computed when there are multiple color channels.
11. The apparatus of clause 9 wherein the application is configured for performing a color transformation that maps an original multi-stimulus color space into a dominant single-stimulus color space, and computing only one GLCM.
12. The apparatus of clause 9 wherein the application is configured for using a directional, user-specified neighborhood by relaxing a search space around the voxel in a specific direction specified by a non-regular bounding box.
13. The apparatus of clause 12 wherein the specific direction specified by the non-regular bounding box comprises vertical, horizontal or diagonal.
14. The apparatus of clause 9 wherein the texture metrics comprise: energy, entropy, correlation, homogeneity or contrast.
15. The apparatus of clause 9 wherein the application is configured for performing a point cloud classification based on the texture metrics.
16. The apparatus of clause 9 wherein the set of voxels are within a 6-D joint (x, y, z, R, G, B) dimensions sparse signal.
17. A system comprising:
   an encoder configured for:
      finding a set of voxels;
      computing a Gray-level Co-occurrence Matrix (GLCM) based on colors of two furthest voxels in the set of voxels for each GLCM channel;
      calculating texture metrics from the GLCM; and
      performing a point cloud classification based on the texture metrics; and
   a decoder configured for receiving the point cloud classification.
18. The system of clause 17 wherein one GLCM per channel is computed in when there are multiple color channels.
19. The system of clause 17 wherein the encoder is configured for performing a color transformation that maps an original multi-stimulus color space into a dominant single-stimulus color space, and computing only one GLCM.
20. The system of clause 17 wherein the encoder is configured for using a directional, user-specified neighborhood by relaxing a search space around the voxel in a specific direction specified by a non-regular bounding box.
21. The system of clause 20 wherein the specific direction specified by the non-regular bounding box comprises vertical, horizontal or diagonal.
22. The system of clause 17 wherein the texture metrics comprise: energy, entropy, correlation, homogeneity or contrast.
23. The system of clause 17 wherein the set of voxels are within a 6-D joint (x, y, z, R, G, B) dimensions sparse signal.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
finding a set of voxels;
computing a Gray-level Co-occurrence Matrix (GLCM) based on colors of two furthest voxels in the set of voxels for each GLCM channel; and
calculating texture metrics from the GLCM.

2. The method of claim 1 wherein one GLCM per channel is computed when there are multiple color channels.

3. The method of claim 1 further comprising performing a color transformation that maps an original multi-stimulus color space into a dominant single-stimulus color space, and computing only one GLCM.

4. The method of claim 1 further comprising using a directional, user-specified neighborhood by relaxing a search space around the voxel in a specific direction specified by a non-regular bounding box.

5. The method of claim 4 wherein the specific direction specified by the non-regular bounding box comprises vertical, horizontal or diagonal.

6. The method of claim 1 wherein the texture metrics comprise: energy, entropy, correlation, homogeneity or contrast.

7. The method of claim 1 further comprising performing a point cloud classification based on the texture metrics.

8. The method of claim 1 wherein the set of voxels are within a 6-D joint (x, y, z, R, G, B) dimensions sparse signal.

9. An apparatus comprising:
a non-transitory memory for storing an application, the application for:
finding a set of voxels;
computing a Gray-level Co-occurrence Matrix (GLCM) based on colors of two furthest voxels in the set of voxels for each GLCM channel; and
calculating texture metrics from the GLCM; and
a processor coupled to the memory, the processor configured for processing the application.

10. The apparatus of claim 9 wherein one GLCM per channel is computed when there are multiple color channels.

11. The apparatus of claim 9 wherein the application is configured for performing a color transformation that maps an original multi-stimulus color space into a dominant single-stimulus color space, and computing only one GLCM.

12. The apparatus of claim 9 wherein the application is configured for using a directional, user-specified neighborhood by relaxing a search space around the voxel in a specific direction specified by a non-regular bounding box.

13. The apparatus of claim 12 wherein the specific direction specified by the non-regular bounding box comprises vertical, horizontal or diagonal.

14. The apparatus of claim 9 wherein the texture metrics comprise: energy, entropy, correlation, homogeneity or contrast.

15. The apparatus of claim 9 wherein the application is configured for performing a point cloud classification based on the texture metrics.

16. The apparatus of claim 9 wherein the set of voxels are within a 6-D joint (x, y, z, R, G, B) dimensions sparse signal.

17. A system comprising:
an encoder configured for:
finding a set of voxels;
computing a Gray-level Co-occurrence Matrix (GLCM) based on colors of two furthest voxels in the set of voxels for each GLCM channel;
calculating texture metrics from the GLCM; and
performing a point cloud classification based on the texture metrics; and
a decoder configured for receiving the point cloud classification.

18. The system of claim 17 wherein one GLCM per channel is computed in when there are multiple color channels.

19. The system of claim 17 wherein the encoder is configured for performing a color transformation that maps an original multi-stimulus color space into a dominant single-stimulus color space, and computing only one GLCM.

20. The system of claim 17 wherein the encoder is configured for using a directional, user-specified neighborhood by relaxing a search space around the voxel in a specific direction specified by a non-regular bounding box.

21. The system of claim 20 wherein the specific direction specified by the non-regular bounding box comprises vertical, horizontal or diagonal.

22. The system of claim 17 wherein the texture metrics comprise: energy, entropy, correlation, homogeneity or contrast.

23. The system of claim 17 wherein the set of voxels are within a 6-D joint (x, y, z, R, G, B) dimensions sparse signal.
